(19) United States
(12) Patent Application Publication
(10) Pub. No.: US 2006/0232853 A1
(43) Pub. Date: Oct. 19, 2006

(54) Projection unit for a head-up display

(75) Inventors: Hans-Juergen Dobschal, Kleinromstedt (DE); Arne Troellsch, Grosschwabhausen (DE); Dirk Jahn, Jena (DE)

Correspondence Address: REED SMITH, LLP;ATTN: PATENT RECORDS DEPARTMENT, 599 LEXINGTON AVENUE, 29TH FLOOR, NEW YORK, NY, 10022-7650, US

(73) Assignee: Carl Zeiss Jena GmbH

(21) Appl. No.: 11/403,333

(22) Filed: Apr. 13, 2006

(30) Foreign Application Priority Data
Apr. 14, 2005 (DE) 10 2005 017 207.5

(51) Int. Cl. G02B 23/00; G02B 21/00

(52) U.S. Cl. 359/366

(57) ABSTRACT

The invention is directed to a projection unit for a head-up display comprising an image generator and a first mirror and second mirror for optical imaging which are arranged in a housing one after the other in the light propagation direction in such a way that the beam path is folded twice. It is wherein one of the mirrors has a light-scattering surface shape, the other mirror h/as a light-collecting surface shape, and the two mirrors combined have a common focal point on the image generator.

### CROSS-REFERENCE TO RELATED APPLICATION

This application claims priority of German Application No. 10 2005 017 207.5, filed Apr. 14, 2005, the complete disclosure of which is hereby incorporated by reference.

### BACKGROUND OF THE INVENTION

a) Field of the Invention

The invention is directed to a lensless projection unit for a head-up display comprising an image generator and a first mirror and second mirror for optical imaging which are arranged in a housing one after the other in the light propagation direction in such a way that the beam path is folded twice.

b) Description of the Related Art

EP 0 450 553 B1 describes a display device which is installed in a motor vehicle. A device of this kind is also known as a head-up display. The device uses an image generator, two reflection parts and the windshield as a reflector. Both of the reflection parts have a magnifying effect; that is, they have a concave shape. Their focal lengths are selected in such a way that the image generator lies within the combined focal points.

The arrangement requires a relatively large installation space which is not available particularly for applications in passenger vehicles or aircraft.

DE 69120575T2, EP 0486165A1 and EP 1291701A1 describe other head-up displays which can be realized with two or more mirrors. In practice, it has been shown that the use of concave and/or plane mirrors requires substantial installation space so that requirements particularly for applications in passenger vehicles can be satisfied only with great difficulty.

In view of the situation, the imaging ratio and the size of the image generator or image size must be adapted in order to realize a head-up display at all. Further, the use of concave or plane mirrors for imaging over a curved windshield causes problems because a highly distorted image results.

### OBJECT AND SUMMARY OF THE INVENTION

Therefore, it is the primary object of the invention to provide an optical arrangement for a head-up display in which the installation space is optimized. Optimization can consist in minimizing the optical transmission length and, therefore, the installation space and in lengthening the transmission length. This is advantageous, for example, when additional elements (e.g., shutters) are to be installed. The degrees of freedom for the dimensioning of the head-up display must be limited as little as possible. The image quality must be optimized by keeping the image distortion to a minimum.

This object is met accordance with the invention in that one of the mirrors has a light-scattering surface shape, the other mirror has a light-collecting surface shape, and the two mirrors combined have a common focal point F′ on the image generator. A light-scattering surface shape means that the surface is substantially convex. This means that a toroidal convex surface can be used for this purpose. A light-collecting surface shape means that the surface is substantially concave. This means that a toroidal concave surface can be used for this purpose.

The mirror system divides the imaging action between two different surface shapes. Convex and concave basic mirror shapes are advantageously combined. Through the use of elements of this kind, a displacement of the principal plane is realized which makes it possible to change the transmission length at a given focal length. Accordingly, it is possible to realize an advantageous imaging ratio in spite of limited installation space. Since the distortion in a head-up display is predominantly not rotationally symmetric due to the use of the windshield as a deflecting element, it is useful that the elements of the mirror system are curved differently in a sagittal and meridional axis. Depending on the curvature of the windshield, toroidal, aspheric or even free-form mirror elements are needed to correct the distortion. The mirror elements that are used form a common focal point on the image generator when combined.

In practice, systems comprising two free-form mirrors exhibit a good distortion correction with excellent utilization of installation space with the commercially available dimensions of the image generator and a stationary imaging ratio.

The invention makes it possible to select the focal length in an advantageous range in a head-up display with free-form mirrors and with given transmission length oriented to the installation space.

The invention will be described more fully in the following with reference to drawings.

### BRIEF DESCRIPTION OF THE DRAWINGS

In the drawings:

FIG. 1 shows an optical system for a head-up display with two mirrors with a negative displacement of the principal plane;

FIG. 2 shows a beam path in the optical system according to FIG. 1;

FIG. 3 shows a head-up display using two mirrors;

FIG. 4 shows a folded optical system according to FIG. 1; and

FIG. 5 shows an optical system for a head-up display with two mirrors with a positive displacement of the principal plane.

### DESCRIPTION OF THE PREFERRED EMBODIMENTS

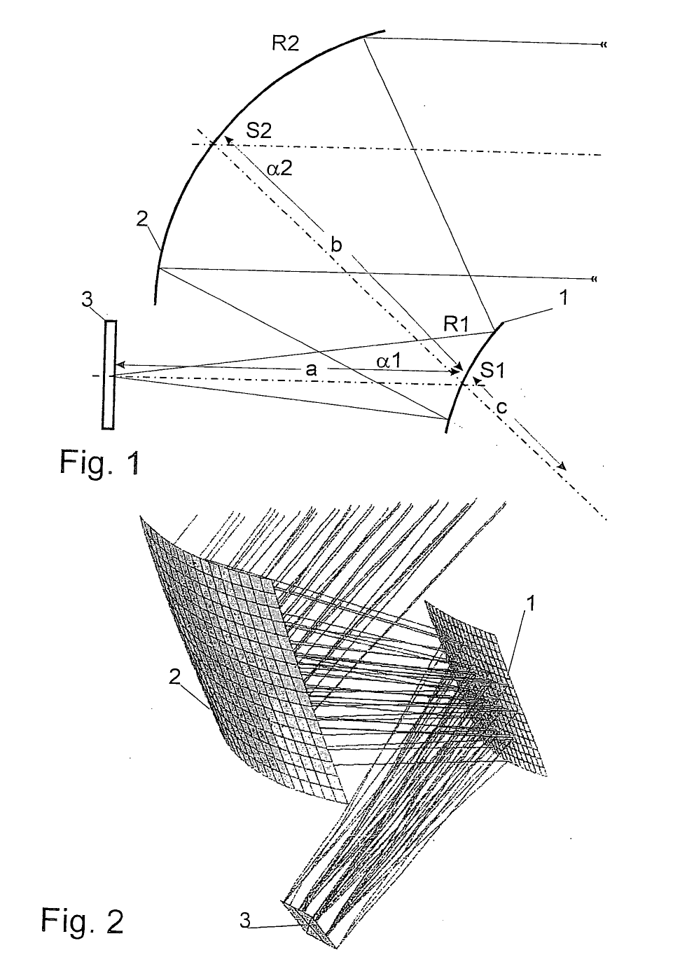

FIG. 1 is a schematic illustration showing the construction of an optical system for a head-up display. An image generator 3 is arranged at a distance a in front of a first mirror 1 which has a convex curvature with a radius R1. This first mirror folds the beam path at an angle α1. A second mirror 2 having a concave curvature with radius R2 is arranged at a distance b from the first mirror 1. The second mirror folds the beam path at an angle α2. The image generator can comprise, for example, a lamp, a laser, or LEDs as light source and can be a DLP, LCOS or LCD type, for example. However, the image generator can also generate light itself and can be, e.g., a plasma panel.

FIG. 2 shows the beam path of the arrangement according to FIG. 1.

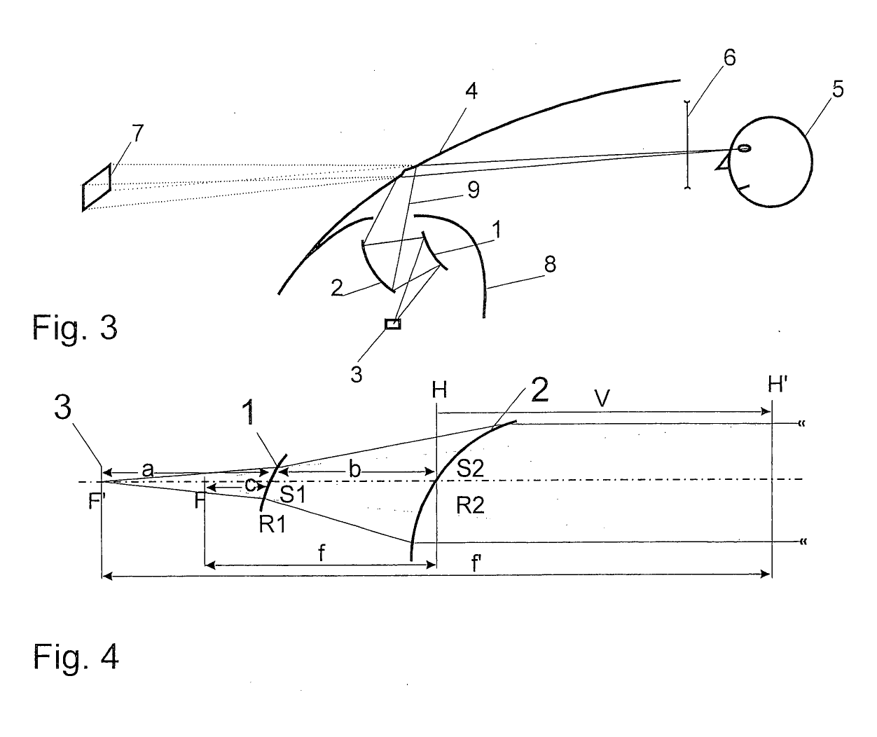

FIG. 3 shows the basic construction of the head-up display in a vehicle. The image generator 3 is arranged with the associated imaging optics inside a dashboard scoop 8. There is an opening in the dashboard scoop 8 from which the projection beams 9 exit and are reflected by a windshield 5 in such a way that a driver 5 can perceive a virtual image 7 inside a viewing area 6. Very exacting, strict demands are applied in the design of the optical system due to the available installation space inside the dashboard scoop 8.

However, the construction of the optical system according to the invention is not limited to accommodation inside the dashboard scoop 8 of the vehicle. Rather, a small installation space is also advantageous when the optical system is used in a different way, e.g., when a virtual image must be projected via the rear windshield or when the projector is arranged in the area of the rearview mirror.

A first embodiment example shows the optical system according to FIG. 1 with a simple negative displacement of the principal plane.

In this system, both mirrors α₁ and α₂ are tilted, respectively, by 25° and have the following parameters:

R₂=300 concave f′=200

R₁=−400 convex a=67 b=100 (in mm)

In this example, the transmission length is 33 mm shorter than the required focal length. In this way, the image generator 3 can be moved closer to the optically imaging system and the installation space is reduced in spite of a constant focal length.

The use of spherical mirrors results in the spherical aberration which can be countered by parabolzing the mirrors. The tilting of the mirrors causes coma and astigmatism which can be compensated by different radii in the meridional section and sagittal section.

This example also shows additional substantial image errors brought about by the shape of an actual windshield of a passenger vehicle.

Errors in the optical imaging are further eliminated in a second embodiment example according to FIG. 1 through the use of biconical mirrors 1 and 2.

The parameters are as follows:

R_{1X}=radius of the first mirror in X-axis

R_{1Y}=radius of the first mirror in Y-axis

k_{1X}=conicity constant of the first mirror in X-axis

k_{1Y}=conicity constant of the first mirror in Y-axis

R_{2X}=radius of the second mirror in X-axis

R_{2Y}=radius of the second mirror in Y-axis

k_{2X}=conicity constant of the second mirror in X-axis

k_{2Y}=conicity constant of the second mirror in Y-axis

R_{2X}=300 k_{2X}=−12 R_{2Y}=280 k_{2Y}=−2.8

R_{1X}=−400 k_{1X}=468 R_{1Y}=−643 k_{1Y}=1533

b=100 a=67 f′=200

Accordingly, this twofold biconical system shows markedly improved results with a tilting of both mirrors α₁ and α₂ by 25°, respectively, despite requirements identical to those in the first embodiment example.

Since this image quality is also often considered inadequate, the use of free-form surfaces is provided which are described, for example, through XY polynomials. In a third embodiment example, XY polynomials up to the third power are used to describe the optically active mirror surfaces. They are described in this example by a sum of XY powers:

$$Z = \frac{{cr}^{2}}{1 + \sqrt{1 - ( 1 + k ) {c}^{2} {r}^{2}}} + {\sum }_{i = 1}^{N} {A}_{i} {E}_{i} ( x , y )$$

where,
Z=sagitta
c=1/R
r=standard radius
Aᵢ=polynomial coefficient
Eᵢ=polynomial term
Second mirror: First mirror:
c=0 r=1 k=0 c=0 r=1 k=0
A₁X¹Y⁰=−3.142574E-009 A₁X¹Y⁰=1.323179E-006
A₂X⁰Y¹=−3.501228E-006 A₂X⁰Y¹=−1.096888E-004
A₃X²Y⁰=1.837444E-003 A₃X²Y⁰=1.335020E-003
A₄X¹Y¹=1.904330E-007 A₄X¹Y¹=1.170568E-006
A₅X⁰Y²=1.489580E-003 A₅X⁰Y²=9.452308E-004
A₆X³Y⁰=9.264556E-010 A₆X³Y⁰=6.885050E-009
A₇X²Y¹=−3.374500E-006 A₇X²Y¹=−2.335126E-005
A₈X¹Y²=1.330162E-009 A₈X¹Y²=9.553471E-009
A₉X⁰Y³=−2.710688E-006 A₉X⁰Y³=−1.726566E-005
b=100 a=67 f′=200

Image quality is optimized by means of a solution of the kind described above. The great variability in the dimensioning of the optical arrangement makes it possible to adapt them to the existing installation space. The use of free-form surfaces makes it possible to incorporate virtually any shapes of the windshield in the calculation of the optical system.

FIG. 4 shows the folded system according to FIG. 1. Without a displacement of the principal plane, the structural length (or transmission length) is equal to the focal length of the mirror system c+b=f. With a displacement of the principal plane, an appreciably greater focal length f can be realized a+b<<f′ with a comparatively small structural length.

In this connection, the total focal length f′determines the viewing angle and, therefore, the apparent size of the viewed image field.

R₁=radius of mirror 1

R₂=radius of mirror 2

b=spacing between mirror 1 and mirror 2

a=distance between mirror 1 and imager

f′=focal length (in mm),

where
f′=R₁*R₂/(2*(R₁+R₂−2b)) and a=R₁*(R₂−2b)/(2*(R₁+R₂−2b)).

The equation shows that the available installation space, which is substantially equal to the distance b between the two mirrors, can be influenced in a fixed image field by the radii R₁ and R₂ of the mirrors. A displacement of the principal plane in the system is carried out when the transmission length of a system is not equal to the focal length, i.e., a+b≠f′).

An example without displacement of the principal plane shows the following results:

R₂=400 concave f′=200

R₁=oo plane

a=100 b=100

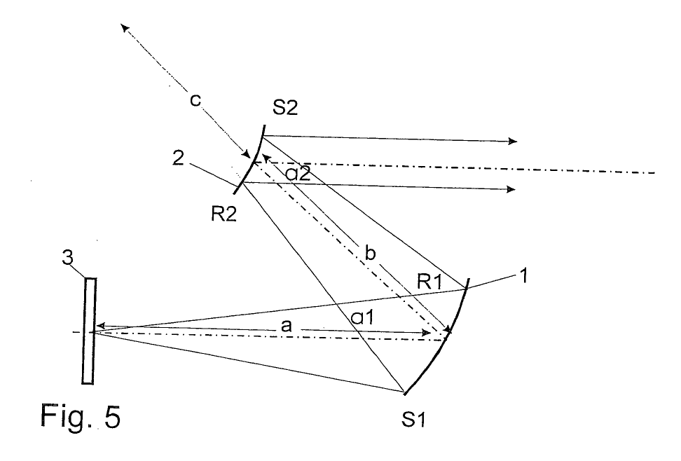

This means that the transmission length must always be equal to the focal length. The imaging laws relating to the spherical mirror with f′=R/2 are applicable in this connection. Compared with the embodiment examples presented above, it can be seen that the transmission length is decreased by 33 mm by means of the inventive solution according to FIG. 1. In the example shown in FIG. 5, the transmission length is lengthened by 200 mm.

FIG. 5 shows another embodiment example with a positive displacement of the principal plane:

R₁=300 concave f′=200

R₂=−400 convex a=300 b=100

In this example, the transmission length is 200 mm longer than the required focal length. Accordingly, with the same viewing angle and the same size of the image generator, the system can be expanded by greater radii and the image generator can be arranged in accordance with the installation space.

While the foregoing description and drawings represent the present invention, it will be obvious to those skilled in the art that various changes may be made therein without departing from the true spirit and scope of the present invention.

### REFERENCE NUMBERS

1 first mirror
2 second mirror
3 image generator
4 windshield
5 driver
6 eye box
7 virtual image
8 dashboard scoop
9 projection beams
S₁ vertex of the first mirror
R₁ radius of the first mirror
f focal length of the first mirror
F focal point of the first mirror
H principal plane of the first mirror
S₂ vertex of the second mirror
R₂ radius of the second mirror
f′ focal length of the total system
H′ focal point of the total system
V principal plane of the total system
a displacement of the principal plane
b distance F′-S2
c distance S2-S1
distance F-S2
α₁ folding angle at the first mirror
α₂ folding angle at the second mirror

What is claimed is:

1. A projection unit for a head-up display comprising:
an image generator, a first mirror and a second mirror for optical imaging;
said image generator, first mirror and second mirror being arranged in a housing one after the other in the light propagation direction in such a way that the beam path is folded twice;
one of said mirrors having a light-scattering surface shape, the other mirror having a light-collecting surface shape; and
said two mirrors combined having a common focal point on the image generator.

2. The projection unit according to claim 1, wherein the first mirror has a light-scattering surface shape and the second mirror has a light-collecting surface shape.

3. The projection unit according to claim 1 wherein the first mirror has a light-collecting surface shape and the second mirror has a light-scattering surface shape.

4. The projection unit according to claim 2, wherein the first mirror or the second mirror is curved differently in its sagittal axis and in its meridional axis.

5. The projection unit according to claim 3, wherein the first mirror or the second mirror is curved differently in its sagittal axis and in its meridional axis.

6. The projection unit according to claim 2, wherein the first mirror and the second mirror are curved differently in the sagittal axes and in the meridional axes.

7. The projection unit according to claim 3, wherein the first mirror and the second mirror are curved differently in the sagittal axes and in the meridional axes.

8. The projection unit according to claim 4, wherein the first mirror and/or the second mirror are/is curved toroidally in their sagittal axes and/or in their meridional axes.

9. The projection unit according to claim 6 wherein the first mirror and/or the second mirror are/is curved toroidally in their sagittal axes and/or in their meridional axes.

10. The projection unit according to claim 4, wherein the first mirror and/or the second mirror are/is curved aspherically in their sagittal axes and/or in their meridional axes.

11. The projection unit according to claim 2, wherein the first mirror and/or the second mirror have/has free-form surface(s).
